(19) United States
(12) Patent Application Publication
(10) Pub. No.: US 2013/0014383 A1
(43) Pub. Date: Jan. 17, 2013

(54) MANIPULATOR, LOADER, AND POSITIONING STRUCTURE FOR PRODUCTION LINE

(71) Applicants: YU-CHING LIU, Tu-Cheng (TW); FU-CHI YANG, Tu-Cheng (TW); CHI-AN YU, Tu-Cheng, New Taipei (TW); YAN-HAO LI, Shenzhen City (CN); XING XIA, Shenzhen City (CN); WEN-ZHAO WU, Shenzhen City (CN)

(72) Inventors: YU-CHING LIU, Tu-Cheng (TW); FU-CHI YANG, Tu-Cheng (TW); CHI-AN YU, Tu-Cheng, New Taipei (TW); YAN-HAO LI, Shenzhen City (CN); XING XIA, Shenzhen City (CN); WEN-ZHAO WU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/482,378

(22) Filed: May 29, 2012

(30) Foreign Application Priority Data
Jul. 13, 2011 (CN) 201110195502.0

(51) Int. Cl. B23P 19/00

(52) U.S. Cl. 29/739

(57) ABSTRACT

A manipulator includes a main body, and a grasping device mounted to the main body. The grasping device includes a mounting board and two grasping members secured on the mounting board. The two grasping members move towards and away from each other, each grasping member is able to grasp a loader at a specific position of the loader.

### BACKGROUND

1. Technical Field

The present disclosure relates to positioning structures, and more particularly to a manipulator, a loader, and a positioning structure for a production line.

2. Description of Related Art

Automatic production lines, such as a production line for automatically detecting and positioning a printed circuit board (PCB), use manipulators to transfer a loader while loading a PCB from the production line to a positioning board. The loader should be placed in a specific position to be detected. To place the loader in position, a positioning structure is disposed on the production line to adjust the loader to the specific position. However, the positioning structure will increase the size of the area occupied by the complete production line.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a production line having a positioning structure.

FIG. 2 is an exploded view of the production line in FIG. 1.

FIG. 3 is an exploded view of the positioning structure in FIG. 1.

FIG. 4 is an exploded view of the positioning structure in FIG. 3.

FIG. 5 is an inverted view of the positioning structure in FIG. 4.

FIG. 6 shows the positioning structure is in a state of working.

FIG. 7 is similar to FIG. 6, but viewed from a rear aspect.

### DETAILED DESCRIPTION

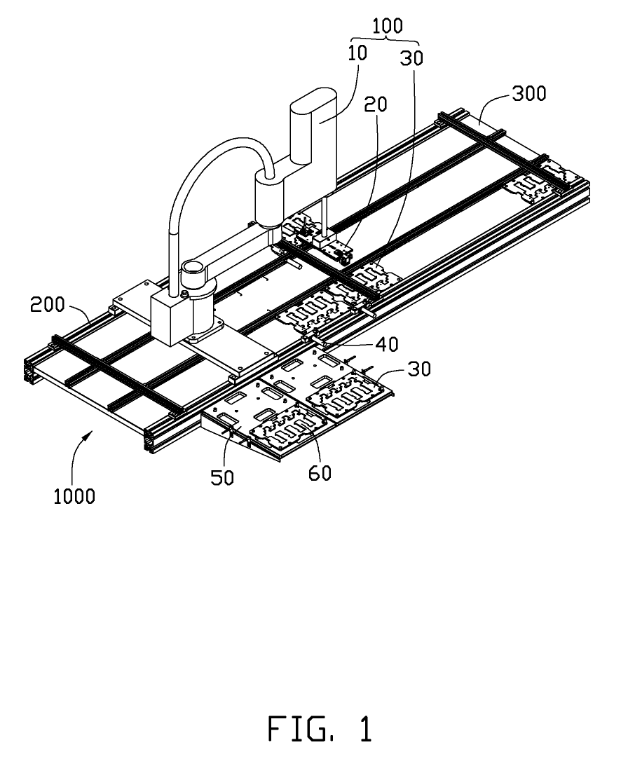

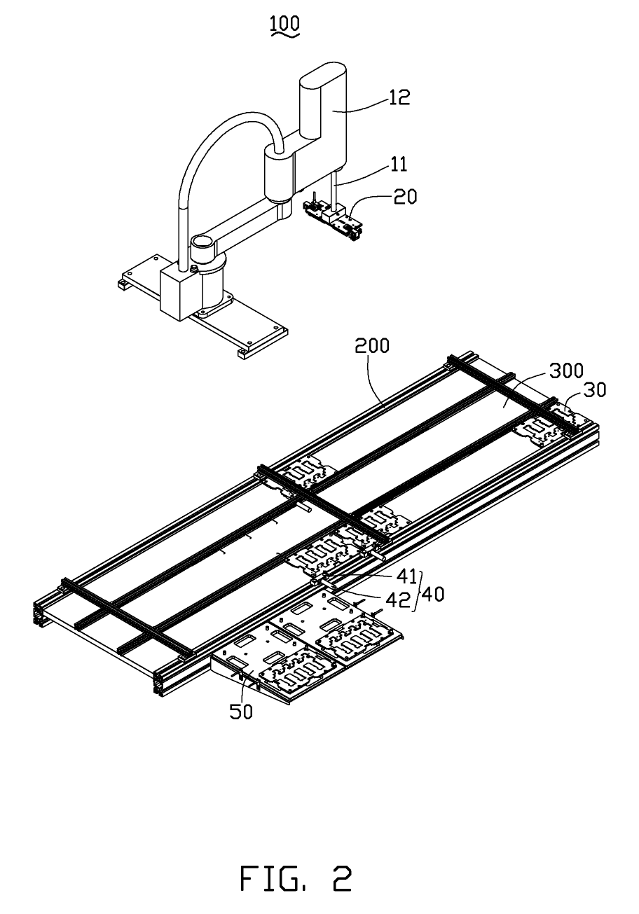

FIGS. 1 and 2, show a positioning structure 100 for a production line 1000. In this embodiment, the production line 1000 is capable of combining work stations in series to automatically produce printed circuit boards (PCBs) 60. The work stations may be work stations for distributing the PCBs 60, and work stations for detecting PCBs 60, for example. The production line 1000 includes two parallel rails 200, a plurality of conveyer belts 300 placed parallel between the rails 200, and a plurality of positioning boards 50 placed on one side of the rails 200.

The positioning structure 100 includes a loader 30 for loading the PCB 60 for movement along the conveyor belts 300. A manipulator 10 slidably mounted to the two rails 200, and a plurality of stopping cylinders 40 positioned on one side of the rails 200.

The stopping cylinders 40 are capable of stopping the loader 30 at a specific position of the conveyor belts 300. Each of the stopping cylinders 40 includes a sensor 41, and a blocking arm 42. The sensor 41 detects whether the loader 30 exists. The blocking arm 42 is driven by the sensor 41 to extend to the conveyor belt 300 to stop the loader 30 from moving when the loaders 30 are detected.

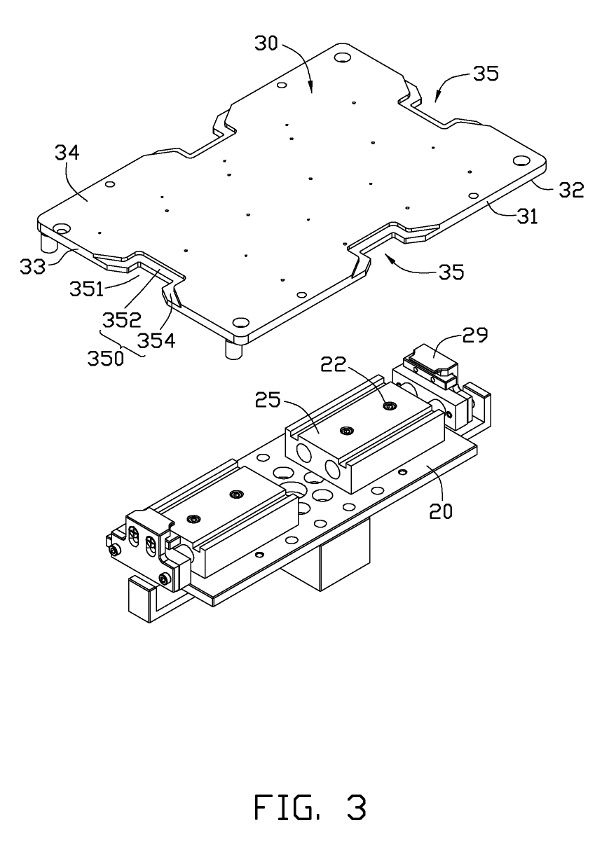

As FIG. 3 shows, the loader 30 is substantially a rectangular board. The loader 30 includes a loading surface 32, a rear surface 34 opposite to the loading surface 32, opposite first side walls 31 and opposite second side walls 33 joining the loading surface 32 and the rear surface 34. Four guiding indentions 35 are defined on four specific positions of the loader 30. The four specific positions are defined on the middle of the first and the second side walls 31 and 33, and the specific positions are symmetrical. Each guiding indention 35 defines a recess 350 and a gap 351 in the recess 350. The recess 350 is recessed downwards from the rear surface 34. The recess 350 includes a rectangular recess 352, and a trapeziform recess 354 communicating with the rectangular recess 352. The trapeziform recess 354 begins from one of the first side walls 31 and the second side walls 33 correspondingly. The gap 351 runs from the trapeziform recess 354 to the middle of the rectangular recess 352. The outline of the gap 351 is as the same as the outline of the recess 350.

The manipulator 10 includes a main body 12 slidably mounted to the two rails 200, a vertical shank 11 protruding from the main body 12 and directly above the conveyer belts 300, and a grasping device 20 mounted to the shank 11. The main body 12 reciprocates along the rails 200. The grasping device 20 grasps the loader 30 by the guiding indention 35.

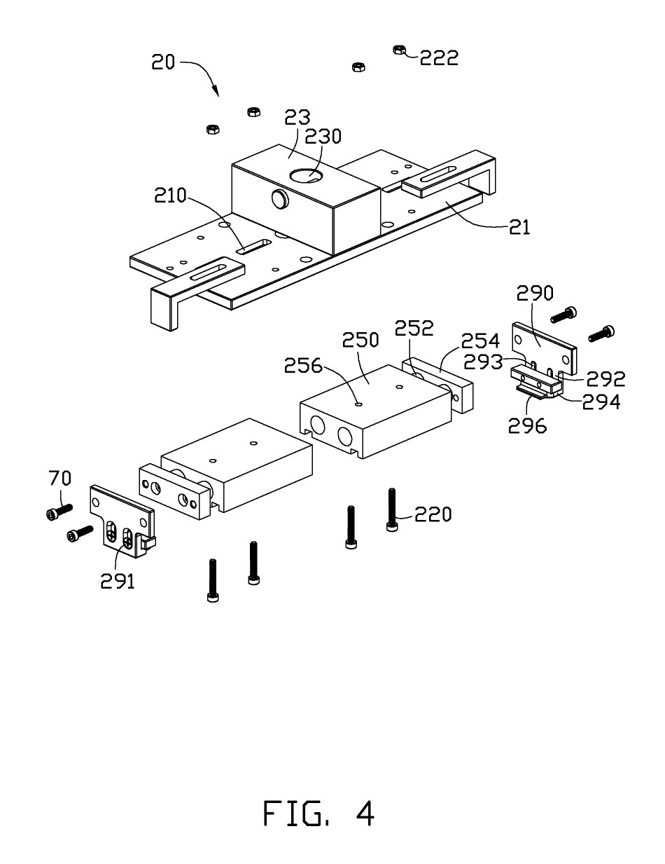

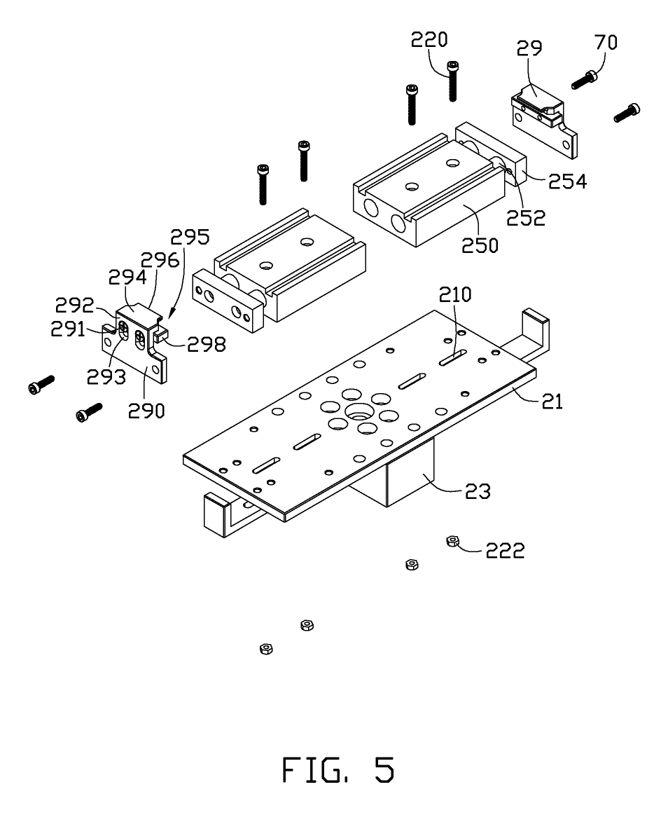

FIGS. 4 and 5, show the grasping device 20 includes a mounting board 21 connected to the shank 11, two drive cylinders 25, and two pairs of first adjusting members 22 for mounting the two drive cylinders 25 to the mounting board 21, and two grasping members 29 fixed on the two drive cylinders 25.

The mounting board 21 is a rectangular board. A fixing member 23 protrudes from the middle of the mounting board 21, and two pairs of first adjusting slots 210 are defined on the mounting board 21. The fixing member 23 is a cuboid shaped block, and has a mounted hole 230 to enable the shank 11 to engage with the fixing member 23, thus the grasping device 20 is secured to the shank 11. The two pairs of first adjusting slots 210 are elliptic holes having a center arranged in a straight line, and the two pairs of first adjusting slots 210 are positioned on two opposite sides of the fixing member 23 symmetrically.

Each of the drive cylinders 25 includes a cylinders body 250 and two drive arms 252. The drive arms 252 reciprocate with respect to the cylinder body 250. A pair of fixing holes 256 are defined on the cylinder body 250 at intervals, a fixing board 254 is connected to one end of the drive arm 252 and away from the cylinder body 250. The fixing board 254 is a rectangular board.

Each first adjusting member 22 includes a screw 220 and a nut 222. Each screw 220 is passed through one fixing hole 256 and one first adjusting slot 210 in that order and then engaged with the nut 222, such that the drive cylinders 25 are secured on the mounting board 21, and the two fixing boards 254 are positioned on two opposite sides of the mounting board 21. Furthermore, each adjusting member 22 is capable of moving along the corresponding adjusting slot 210 to change their position with respect to the mounting board 21, thus the position relationship of the two drive cylinders 25 are changeable, and the position relationship of the two fixing boards 254 can be changeable.

The two grasping members 29 are positioned on opposite sides of the mounting board 21 corresponding to the two guiding indentions 35. The two grasping members 29 can be guided to engage the two guiding indentions 35 to grasp the loader 30, thus the loader 30 can be arranged in a specific orientation with respect to the manipulator 10. Each grasping member 29 includes a first base board 290, a second base board 292, a third base board 294, a first grasping part 296, a second grasping part 298, and two second adjusting members 291.

The second base board 292 is a rectangular board, and defines two second adjusting slots 293. The second adjusting slots 293 are elliptic holes. The first based board 290 and the third base board 294 extend from opposite ends of the second base board 292 along two perpendicular directions. The first based board 290 horizontally extends from the second base board 292, and is fixed on one fixing board 254. The appearance of the first base board 290 fits the fixing board 254. The third based board 294 vertically extends from the first base board 290 and under the corresponding drive cylinder 25.

The first grasping part 296 horizontally extends from one end of the third board 294 and away from the second base board 292. The thickness and width of the grasping part 296 are smaller than that of the third based board 294 (see FIG. 4). The second grasping part 298 is a narrow rectangular board, mounted to the second base board 292 via the second adjusting member 291. The second grasping member 298 covers the first grasping part 296, and there is a space 295 between the first and the second grasping parts 296 and 298.

Each second adjusting member 291 is a screw, and is passed through the second base board 292 via the second adjusting slots 293 to engage the second grasping part 298. Each second adjusting member 291 moves along one of second adjusting slots 293. Thus, the second grasping part 298 is secured on the second base board 292 and moves to and away from the first grasping part 296, thus the width of the space 295 can be changeable. One guiding indention 35 is sandwiched between the first grasping part 296 and the second grasping part 298. The capabilities of the positioning structure 100 can be best described as below.

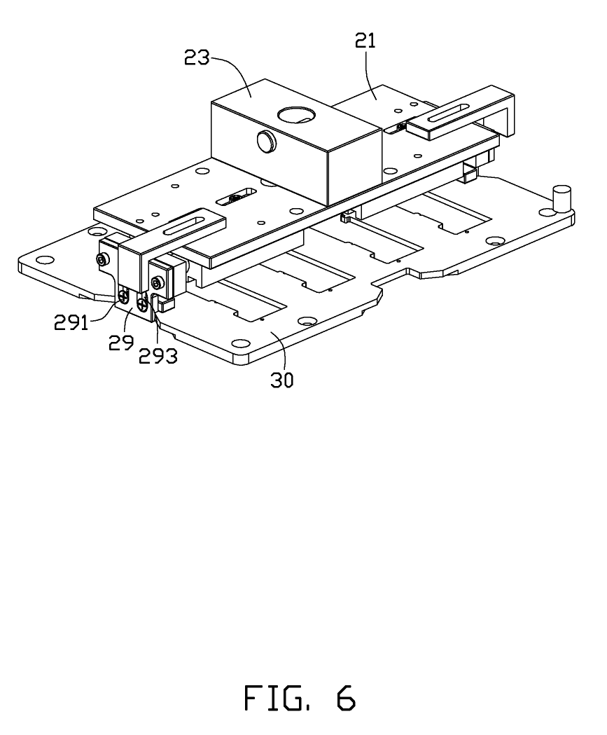

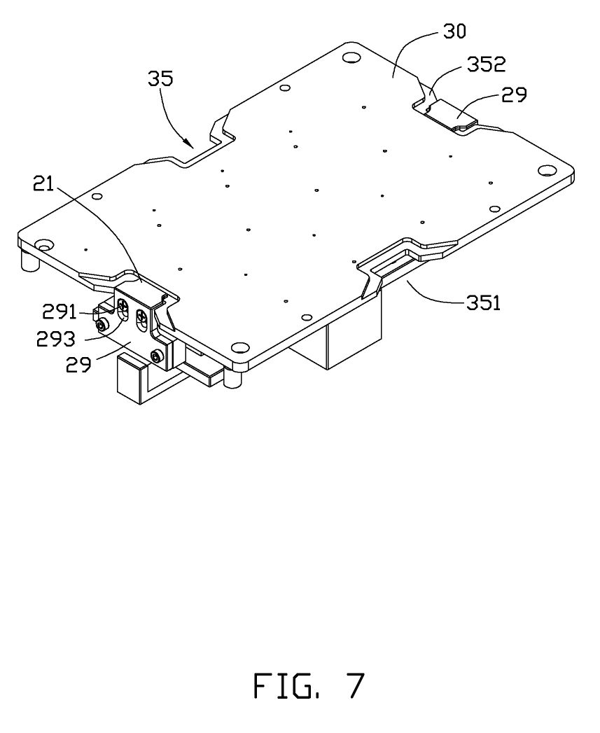

FIGS. 6 and 7, shown in this embodiment, the original state of the positioning structure 100 is that the two drive arms 252 are driven to extend farthest from the cylinder bodies 250 along opposite directions. First, the stopping cylinders 40 determine whether the loader flows on the conveyor belts 300, and drive the blocking arms 42 to stop the loader 30 when detected, as a result, the loader 30 can be approximately located. Second, the manipulator 10 is driven to move to one stopped loader 30 and enables the grasping device 20 above the one loader 30. Third, the gasping device 20 is driven to move down to the stopped loader 30, the two gasping member 29 are adjacent to opposite guiding indentions 35, and are driven to move to each other, the first grasping part 296 and the second grasping part 298 of each grasping member 29 are guided by the recesses 350 to grasp the corresponding guiding indention 35, thus the stopped loader 30 is specifically located. The first grasping part 296 and the second grasping part 298 clip on two opposite sides of the guiding indentions 35. For example, the first grasping part 296 is placed on the recess 350. The second grasping part 298 is placed on the side of the guiding indention 35 opposite to the recess 350. Fourth, after the loader 30 is located by the positioning structure 100, the manipulator 10 taking the grasping device 20 moves to the positioning board 50, the two grasping members 29 are driven to move away from each other by the drive cylinders 25 when the loader 30 is adjacent to the positioning board 50, for example, a distance between loader 30 and the positioning board is 3 mm. Thus the loader 30 is released from the two grasping member 29 and placed on the positioning board 50.

The distance between the two grasping members 29 can be determined according to the length or width of the loader 30, and obtained by adjusting the position relationship between the first adjusting member 22 and the mounting board 21. The distance between the first grasping part 296 and the second grasping part 298 can be determined according to the thickness of the loader 30, and obtained by adjusting the position relationship between the second adjusting member 291 and the second base board 292. The edges of the recesses 350 positioned on the first sides wall 31 or the second sides wall 33 are widest, thus, it allows the grasping members 29 to be guided easily.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A manipulator for positioning a loader for loading workpieces, the manipulator comprising:
a main body, and
a grasping device mounted to the main body, the grasping device having a mounting board, and two grasping members secured on the mounting board, the two grasping members being capable of moving towards and away from each other, each grasping member being able to grasp the loader at a special position of the loader.

2. The manipulator of claim 1, wherein the two grasping members are positioned on the opposite sides of the mounting board, and the position relationship between each grasping member and the mounting board can be changeable.

3. The manipulator of claim 2, wherein the grasping device further comprises two drive cylinders mounted to the mounting board, each cylinder comprises a cylinder body and a drive arm, the two grasping members are mounted to the drive arms of the two drive cylinders, the cylinder bodies of the two drive cylinders are capable of driving the drive arms to move to and away from the cylinder bodies, as a result the two grasping members can move to and away from each other.

4. The manipulator of claim 3, wherein the grasping device further comprises two first adjusting members, the mounting board defines two first adjusting slots, each of the first adjusting members is capable of mounting one of the drive cylinders to the mounting board via one first adjusting slot, and each first adjusting member can move along the one first adjusting slot.

5. The manipulator of claim 4, wherein each first adjusting member comprises a first screw and a nut, the first screw passes through the drive cylinders and the mounting board in that order to engage to the nut via the first adjusting slot.

6. The manipulator of claim 3, wherein each grasping member comprises a first base board, a second base board, a first grasping part, and a second grasping part, the first base board is secured to the drive arm, the second base board horizontally extends from the first base board, the first grasping part perpendicularly extend from the second base board, the second grasping part is secured to the second base board and faces the first grasping part, the loader is sandwiched between the first grasping part and the second grasping part.

7. The manipulator of claim 6, wherein the grasping device further comprises a second adjusting member, the second base board defines a second adjusting slot, the second adjusting member passes through the second adjusting slot to engage in the second grasping part, the second adjusting member is capable of moving along the second adjusting slot to change the position relationship between the first grasping part and the second grasping part.

8. A loader being grasped by a manipulator, the loader comprising:
a loader surface;
a rear surface opposite to the loader surface; and
opposite side walls connected between the loader surface and the rear surface; and
at least two guiding indentions to guide the manipulator to grasp the loader by specify positions, each guiding indention defining a recess on the rear surface beginning from one side wall, and a gap defined in the recess, an outline of the gap being the same as that of the recess.

9. The loader of claim 8, wherein the recess comprises a rectangular recess, and a trapeziform recess communicating to the rectangular recess, the trapeziform recess begins from one side wall, the gap runs from the trapeziform recess to the middle of the rectangular recess.

10. A positioning structure comprising:
a manipulator having a main body, and a grasping device mounted to the main body, the grasping device having a mounting board, and two grasping members secured on the mounting board, the two grasping members being capable of moving towards and away from each other; and
a loader defining two symmetrical guiding indentions on two opposite sides of the loader, the guiding indentions guiding the two grasping members to grasp the loader at the two guiding indentions.

11. The positioning structure of claim 10, wherein the two grasping members are positioned on the opposite sides of the mounting board, and the position relationship between each grasping member and the mounting board can be changeable.

12. The positioning structure of claim 11, wherein the grasping device further comprises two drive cylinders mounted to the mounting board, each cylinder comprises a cylinder body and a drive arm, the two grasping members are mounted to the drive arms of the two drive cylinders, the cylinder bodies of the two drive cylinders are capable of driving the drive arms to move away from the cylinder bodies, as a result the two grasping members can move to and away from each other.

13. The positioning structure of claim 12, wherein the grasping device further comprises two pairs of first adjusting members, the mounting board defines two pairs of first adjusting slot, each pair of the first adjusting members are capable of mounting one of the drive cylinders to the mounting board via each pair of the first adjusting slots, and each first adjusting member can move along the corresponding first adjusting slot.

14. The positioning structure of claim 13, wherein each first adjusting member comprises a first screw and a nut, the first screw passes through the drive cylinders and the mounting board in that order to engage to the nut via the first adjusting slot.

15. The positioning structure of claim 12, wherein each grasping member comprises a first base board, a second base board, a first grasping part, and a second grasping part;
the first base board is secured to the drive arm; the second base board horizontally extends from the first base board; the first grasping part perpendicularly extend from the second base board; the second grasping part is secured to the second base board and faces the first grasping part; the loader is sandwiched between the first grasping part and the second grasping part.

16. The positioning structure of claim 15, wherein the grasping device further comprises a second adjusting member, the second base board defines a second adjusting slot, the second adjusting member passes through the second adjusting slot to engage the second grasping part, the second adjusting member is capable of moving along the second adjusting slot to change the position relationship between the first grasping part and the second grasping part.
